(19) United States
(12) Patent Application Publication
(10) Pub. No.: US 2025/0034178 A1
(43) Pub. Date: Jan. 30, 2025

(54) SILYLBENZOPINACOL RADICAL INITIATORS

(71) Applicant: WACKER CHEMIE AG, Munich (DE)

(72) Inventors: Theresa DELLERMANN, Munich (DE); Armin FEHN, Mehring (DE); Dieter HELDMANN, Burghausen (DE); Ramona WALCH, Munich (DE)

(73) Assignee: WACKER CHEMIE AG, Munich (DE)

(21) Appl. No.: 18/696,698

(22) PCT Filed: Oct. 5, 2021
(86) PCT No.: PCT/EP2021/077402

§ 371 Date: Mar. 28, 2024

(51) Int. Cl. C07F 7/08

(52) U.S. Cl. CPC C07F 7/0896

(57) ABSTRACT

A method for preparing silyl benzopinacol free-radical initiators includes reacting benzophenone with a reductant selected from alkali metal and alkaline earth metal and silane of the general formula R¹R²SiCl₂ (I). In general formula (I), R¹ is a C3-C32 alkyl radical and R² is a C1-C32 alkyl radical or Cl.

The invention relates to a method for producing silyl benzopinacol free-radical initiators from benzophenone, reductant, and chloroalkyl silane.

Silyl benzopinacols are thermal free-radical initiators used for controlled crosslinking of unsaturated resins. They are prepared, as described by way of example in DE2632294A, by the reaction of benzophenone with magnesium and subsequent addition of an alkyl dichlorosilane or alkyl trichlorosilane having a C1 or C2 alkyl radical or mixtures. Typically, methyltrichlorosilane or dimethyldichlorosilane is used, which after hydrolysis and workup result in a complex, active product mixture.

The products obtainable by the known literature methods (see comparative example 1) are turbid, inhomogeneous suspensions. They show the desired reactivity as free-radical initiators for unsaturated, free-radically polymerizable substances. However, their inhomogeneity makes it difficult to set the curing rate of unsaturated, free-radically polymerizable substances exactly, especially on an industrial scale, and the dosing of the free-radical initiator often needs to be corrected further in order to obtain thermally polymerizable mixtures having a constant curing rate.

In addition, settling of the finely dispersed solid in the suspension results during storage in sediment formation. These separated suspensions need to be laboriously rehomogenized through an additional work step, which understandably often leads to problems on an industrial scale for those skilled in the art.

DE2615039A1 describes monomeric benzopinacol silyl ethers for use as free-radical initiators, which can be prepared by the reductive reaction of benzophenone with trialkyl monochlorosilanes. The products may, depending on the substituents, be present as solids or liquids; in the case of long-chain alkyl substituents it is possible to obtain liquid, homogeneous products. However, these show much lower activities compared to their oligomeric representatives obtainable from dialkyl dichlorosilanes or alkyl trichlorosilanes. This makes them less suitable for industrial use.

There is therefore a need for free-radical initiators that are present as homogeneous solutions and at the same time show high reactivity. With increasing reactivity of the free-radical initiator, the amount of free-radical initiator can be reduced, which is preferable for cost reasons.

The invention provides a method for preparing silyl benzopinacol free-radical initiators, in which benzophenone is reacted with a reductant selected from alkali metal and alkaline earth metal and silane of the general formula (I)

R¹R²SiCl₂ (I),

in which
R¹ is a C3-C32 alkyl radical and
R² is a C1-C32 alkyl radical or Cl.

The invention also provides the silyl benzopinacol free-radical initiators obtainable by the method.

The silyl benzopinacol free-radical initiators of the invention are clear and homogeneous product mixtures, which considerably facilitates their use in applications. The initiator mixtures are liquid on account of the long-chain alkyl substituents on the silicon atom, and show no turbidity. They are consequently more readily processible, since they cause no sedimentation, which would otherwise give rise to fluctuations in activity. They show high reactivity as free-radical initiators.

The reductant is selected preferably from lithium, sodium, potassium, magnesium, and calcium and is especially magnesium.

A silane of the general formula (I) or a mixture of different silanes of the general formula (I) can be used.

The alkyl radicals R¹ may be linear, branched or cyclic. Examples of alkyl radicals R¹ are the n-propyl, isopropyl, n-butyl, sec-butyl, isobutyl, tert-butyl, n-pentyl, sec-pentyl, isopentyl, neopentyl, and tert-pentyl radical; hexyl radicals, such as the n-hexyl radical; heptyl radicals, such as the n-heptyl radical; octyl radicals, such as the n-octyl radical, and isooctyl radicals, such as the 2,4,4-trimethylpentyl radical; nonyl radicals, such as the n-nonyl radical; decyl radicals, such as the n-decyl radical; dodecyl radicals, such as the n-dodecyl radical; hexadecyl radicals, such as the n-hexadecyl radical; octadecyl radicals, such as the n-octadecyl radical; cycloalkyl radicals, such as the cyclopentyl, cyclohexyl, cycloheptyl radical and methylcyclohexyl radical.

In a preferred embodiment, R¹ is an alkyl radical having 3 to 20 carbon atoms, especially 3 to 10 carbon atoms.

The alkyl radicals R¹ may be linear, branched or cyclic. Examples of alkyl radicals R² are the methyl and ethyl radical and also the alkyl radicals listed for R¹. In a preferred embodiment, R² is an alkyl radical having 1 to 6 carbon atoms, especially a methyl, ethyl, n-propyl or isopropyl radical, especially a methyl radical

In a preferred embodiment, R¹ is an alkyl radical having 3 to 18 carbon atoms and R² is Cl.

Surprisingly, silyl benzopinacols from dialkyl dichlorosilanes have increased reactivity. This increased reactivity could already be observed with dimethyldichlorosilane, but the corresponding silyl benzopinacol is a solid and therefore processible only poorly or not at all. Increased reactivity can be observed in a mixture with methyltrichlorosilane too, but the product is also turbid or solid.

In particular, products from dialkyl dichlorosilanes surprisingly show significantly increased reactivity compared to their alkyl trichlorosilane analogs.

In a preferred embodiment, R¹ is accordingly an alkyl radical having 3 to 32 carbon atoms and R² an alkyl radical having 1 to 32 carbon atoms, preferably R¹ is an alkyl radical having 3 to 20 carbon atoms and R² an alkyl radical having 1 to 20 carbon atoms, more preferably R¹ is an alkyl radical having 6 to 12 carbon atoms and R² an alkyl radical having 1 to 3 carbon atoms, in particular R¹ is an alkyl radical having 6 to 14 carbon atoms and R² a methyl radical.

The process may be executed in the presence or in the absence of aprotic solvents. Preference is given to aprotic and polar solvents. If aprotic solvents are used, preference is given to solvents or solvent mixtures having a boiling point or boiling range of up to 250° C. at 0.1 MPa. Examples of such solvents are ethers, such as dioxane, tetrahydrofuran, diethyl ether, methyl tert-butyl ether, diisopropyl ether, and diethylene glycol dimethyl ether; chlorinated hydrocarbons, such as dichloromethane, trichloromethane, tetrachloromethane, 1,2-dichloroethane, and trichloroethylene; hydrocarbons, such as pentane, n-hexane, hexane isomer mixtures, heptane, octane, mineral spirits, petroleum ether, benzene, toluene, and xylenes; siloxanes, especially linear dimethylpolysiloxanes with trimethylsilyl end groups and having preferably 0 to 6 dimethylsiloxane units or cyclic dimethylpolysiloxanes having preferably 4 to 7 dimethylsiloxane units, for example hexamethyldisiloxane, octamethyltrisiloxane, octamethylcyclotetrasiloxane, and decamethylcyclopentasiloxane; N,N-disubstituted amides, such as dimethylformamide, N,N-dimethylacetamide, and phosphoric tris (dimethylamide); alkyl phosphates, such as trialkyl phosphates and especially triethyl phosphate, or mixtures of these solvents.

Preference is given to ethers, hydrocarbons, trialkyl phosphates, and mixtures thereof.

The term “solvent” does not mean that all reaction components necessarily dissolve therein. The reaction may also be carried out in a suspension or emulsion of one or more reactants. The reaction may also be carried out in a solvent mixture having a miscibility gap, where at least one of the reactants is soluble in each of the phases of the mixture.

In a preferred embodiment, the reaction is activated with iodine. Preferably, 0.001 to 0.1 mol of iodine is added per mole of reductant.

Preferably, first benzophenone and the reductant and optionally iodine are combined and then the silane of the general formula (I) added.

Preferably, the molar ratio of benzophenone to reductant is between 0.8 and 1.5, especially between 0.9 and 1.1, for lithium, sodium or potassium as reductants, or 0.3 to 0.75, especially 0.4 to 0.6, for magnesium or calcium as reductant.

Preferably, the molar ratio of benzophenone to silane of the general formula (I), based on the Cl, is between 0.6 and 1.8, especially between 0.8 and 1.2.

The method is preferably carried out at a temperature of between 0° C. and 80° C., more preferably between 10°° C. and 60° C., especially between 20° C. and 50° C.

Preferably, the reaction time after adding the silane of the general formula (I) is 30 min to 1 day, more preferably between 1 to 8 h, especially 2 to 6 h.

The reaction is preferably worked up by adding water, neutralizing with a weak base, such as sodium hydrogen carbonate, and removing the aqueous phase.

If the method is carried out in the presence of aprotic solvents, these are preferably removed by distillation.

The silyl benzopinacol free-radical initiators of the invention find use as thermal free-radical initiators for unsaturated vinyl compounds, such as unsaturated polyester resins and styrene.

### Analysis for the Entire Invention

### Measurement of Gel Time for the Determination of Reactivity

The measurement is carried out on a commercially available unsaturated polyester resin (Palatal P04-1) from BÜFA using a gelation measurement device from Rosentreter. For the measurement, the resin is mixed with 1% of the product mixture, transferred to a test tube (160×16 mm) and attached to the gelation device. The sample is heated to 90° C. and the stroke cycle of the plunger and the gelation timer started. The gelation time is stopped as soon as the pressure sensor of the device is triggered.

In the examples that follow, unless stated otherwise in each case, all amounts and percentages are based on weight, all pressures are 0.10 MPa (abs.), and all temperatures are 20° C.

### EXAMPLES

### Example 1 (Noninventive)

50 g of benzophenone is dissolved in xylene at 30° C. and then 3.4 g of magnesium, 15 ml of THF, 34 ml of triethyl phosphate, and 0.06 g of iodine are added. 11 ml of methyltrichlorosilane is metered in over a period of 180 minutes and the reaction is stirred at 40° C. for another 60 minutes. At the end of the reaction 40 ml of water is added during 10 minutes, after which the phases are separated. The organic phase is neutralized with sodium hydrogen carbonate solution and, after renewed phase separation, volatiles are removed by distillation in a short-path evaporator. This affords a viscous, yellow liquid that becomes turbid on storage. The gel time is 9.7 min.

### Example 2 (Noninventive)

50 g of benzophenone is dissolved in xylene at 30° C. and then 3.4 g of magnesium, 15 ml of THF, 34 ml of triethyl phosphate, and 0.06 g of iodine are added. 20 ml of dimethyldichlorosilane is metered in and the reaction is stirred at 40° C. for 4 h. At the end of the reaction 40 ml of water is added during 10 minutes, after which the phases are separated.

The organic phase is neutralized with sodium hydrogen carbonate solution and, after renewed phase separation, volatiles are removed by distillation. This affords a white, poorly soluble solid. The gel time is 6.5 min. The polymerized resin is inhomogeneous.

### Example 3 (Noninventive)

50 g of benzophenone is dissolved in xylene at 30° C. and then 3.4 g of magnesium, 15 ml of THF, 34 ml of triethyl phosphate, and 0.06 g of iodine are added. 35 ml of trimethylchlorosilane is metered in and the reaction is stirred at 40° C. for 4 h. Solid formation can already be observed during the reaction. At the end of the reaction 40 ml of water is added during 10 minutes, after which the aqueous phase is removed. The organic phase and the solid formed are neutralized with sodium hydrogen carbonate solution and, after removal again of the aqueous phase, volatiles are removed by distillation. This affords a white, poorly soluble solid. The gel time is 25 min. The polymerized resin is inhomogeneous.

### Example 4 (Noninventive)

50 g of benzophenone is dissolved in xylene at 30° C. and then 3.4 g of magnesium, 15 ml of THF, 34 ml of triethyl phosphate, and 0.06 g of iodine are added. 64 ml of dimethyloctylchlorosilane is metered in and the reaction is stirred at 40° C. for 4 h. At the end of the reaction 40 ml of water is added during 10 minutes, after which the phases are separated.

The organic phase is neutralized with sodium hydrogen carbonate solution and, after renewed phase separation, volatiles are removed by distillation. This affords a yellow liquid. The gel time is 20 min.

### Example 5

45 g of benzophenone is dissolved in xylene at 30°° C. and then 3.1 g of magnesium, 15 ml of THF, 30 ml of triethyl phosphate, and 0.06 g of iodine are added. 13 ml of propyltrichlorosilane is metered in and the reaction is stirred at 40° C. for 4 h. At the end of the reaction 80 ml of water is added during 10 minutes, after which the phases are separated. The organic phase is neutralized with sodium hydrogen carbonate solution and, after renewed phase separation, volatiles are removed by distillation in a short-path evaporator. This affords a viscous yellow liquid. The product remains clear, even on storage. The gel time is 11 min.

### Example 6

45 g of benzophenone is dissolved in xylene at 30° C. and then 3.1 g of magnesium, 15 ml of THF, 30 ml of triethyl phosphate, and 0.06 g of iodine are added. 20 ml of hexadecyltrichlorosilane is metered in and the reaction is stirred at 40° C. for 4 h. At the end of the reaction 80 ml of water is added during 10 minutes, after which the phases are separated. The organic phase is neutralized with sodium hydrogen carbonate solution and, after renewed phase separation, volatiles are removed by distillation in a short-path evaporator. This affords a viscous yellow liquid. The product remains clear, even on storage. The gel time is 8.9 min.

### Example 7

50 g of benzophenone is dissolved in xylene at 30° C. and then 3.4 g of magnesium, 15 ml of THF, 34 ml of triethyl phosphate, and 0.06 g of iodine are added. 35 ml of methyl-n-octyldichlorosilane is metered in and the reaction is stirred at 40° C. for 4 h. At the end of the reaction 40 ml of water is added during 10 minutes, after which the phases are separated. The organic phase is neutralized with sodium hydrogen carbonate solution and, after renewed phase separation, volatiles are removed by distillation in a short-path evaporator. This affords a viscous yellow liquid. The product remains clear, even on storage. The gel time is 6.2 min.

### Example 8

40 g of benzophenone is dissolved in xylene at 30° C. and then 2.8 g of magnesium, 12 ml of THF, 27 ml of triethyl phosphate, and 0.05 g of iodine are added. 47 ml of methyl-n-octyldichlorosilane is metered in and the reaction is stirred at 40° C. for 4 h. At the end of the reaction 40 ml of water is added during 10 minutes, after which the phases are separated. The organic phase is neutralized with sodium hydrogen carbonate solution and, after renewed phase separation, volatiles are removed by distillation in a short-path evaporator. This affords a viscous yellow liquid. The product remains clear, even on storage. The gel time is 5.9 min.

### Example 9

25 g of benzophenone is dissolved in xylene at 30° C. and then 1.7 g of magnesium, 7.4 ml of THF, 17 ml of triethyl phosphate, and 0.03 g of iodine are added. 25 ml of dioctyldichlorosilane is metered in and the reaction is stirred at 40° C. for 4 h. At the end of the reaction 20 ml of water is added during 10 minutes, after which the phases are separated. The organic phase is neutralized with sodium hydrogen carbonate solution and, after renewed phase separation, volatiles are removed by distillation in a short-path evaporator. This affords a viscous yellow liquid. The product remains clear, even on storage. The gel time is 8.0 min.

1-9. (canceled)

10. A method for preparing silyl benzopinacol free-radical initiators, in which benzophenone is reacted with a reductant selected from alkali metal and alkaline earth metal and silane of the general formula (I)
R¹R²SiCl₂ (I),
in which
R¹ is a C3-C32 alkyl radical and
R² is a C1-C32 alkyl radical or Cl.

11. The method as claimed in claim 10, in which R¹ is an alkyl radical having 3 to 18 carbon atoms and R² is Cl.

12. The method as claimed in claim 10, in which R¹ is an alkyl radical having 3 to 20 carbon atoms and R² an alkyl radical having 1 to 20 carbon atoms.

13. The method as claimed in claim 10, in which the reductant is magnesium.

14. The method as claimed in claim 10, which is carried out in the presence of aprotic solvents.

15. The method as claimed in claim 10, in which the reaction is activated with iodine.

16. The method as claimed in claim 10, in which first benzophenone and the reductant and optionally iodine are combined and then the silane of the general formula (I) added.

17. The method as claimed in claim 10, in which the reaction is worked up by adding water, neutralizing with a weak base, and removing the aqueous phase.
